(19) United States
(12) Patent Application Publication
(10) Pub. No.: US 2021/0119213 A1
(43) Pub. Date: Apr. 22, 2021

(54) BATTERY ELECTRODE WITH SOLID POLYMER ELECTROLYTE AND AQUEOUS SOLUBLE BINDER

(71) Applicants: Michael A. ZIMMERMAN, No. Andover, MA (US); Randolph LEISING, No. Andover, MA (US); IONIC MATERIALS, INC., Woburn, MA (US)

(72) Inventors: Michael A. Zimmerman, North Andover, MA (US); Randolph Leising, No. Andover, MA (US)

(21) Appl. No.: 16/956,246

(22) PCT Filed: Dec. 20, 2018
(86) PCT No.: PCT/US2018/066849

§ 371 Date: Jun. 19, 2020

Related U.S. Application Data
(60) Provisional application No. 62/608,853, filed on Dec. 21, 2017.

(51) Int. Cl. H01M 4/62; H01M 4/133; H01M 4/1393; H01M 4/04; H01M 4/587; H01M 10/0525; H01M 10/0565

(52) U.S. Cl. CPC H01M 4/622; H01M 4/133; H01M 4/1393; H01M 4/0404; H01M 2300/0082; H01M 4/625; H01M 10/0525; H01M 10/0565; H01M 4/587

(57) ABSTRACT

The invention features an electrode useful in an electrochemical cell. The electrode includes an electrochemically active material; an electrically conductive material; a solid ionically conductive polymer electrolyte; and a binder; wherein the binder is dispersed in an aqueous solution. The invention also features a method of making the battery including the electrode.

### STATEMENT REGARDING FEDERALLY SPONSORED RESEARCH OR DEVELOPMENT

Not Applicable.

### BACKGROUND OF THE INVENTION

Methods of making battery electrodes, particularly lithium-ion batteries, typically require binders to both maintain electrode integrity and to ensure adherence with corresponding current collector surfaces. The binders are used in electrode forming processes with appropriate solvents. Non-aqueous solvents are used with binders such as Polyvinylidene fluoride also known as polyvinylidene difluoride. Aqueous binders including water are less toxic, but water can damage electrolytes by, for example, disassociating electrolyte salts from the solute. Thus, prior art use of aqueous binders generally requires processes that isolate the aqueous solution from the electrolyte and/or additional process steps for addition of supplementary electrolyte after the aqueous solution is driven or removed from the electrode.

### BRIEF SUMMARY OF THE INVENTION

It has been surprisingly found that the solid ionically conductive polymer electrolyte described U.S. application Ser. No. 13/861,170 granted as U.S. Pat. No. 9,819,053 and U.S. application Ser. No. 15/148,085 can enable the use of aqueous soluble binders without the previously required step of adding electrolytes. U.S. application Ser. No. 13/861,170 granted as U.S. Pat. No. 9,819,053 and U.S. application Ser. No. 15/148,085 are incorporated herein in their entireties except for any definitions, subject matter disclaimers or disavowals, and except to the extent that the incorporated material is inconsistent with the express disclosure herein, in which case the language in this disclosure controls. The granted patent U.S. Pat. No. 9,819,053 and U.S. application Ser. No. 15/148,085 are included in this specification as respective Attachment A and Attachment B prior to the claim listing in this application.

In one aspect, the invention features an electrode useful in an electrochemical cell. The electrode includes an electrochemically active material; an electrically conductive material; a solid ionically conductive polymer electrolyte; and a binder; wherein the binder is dispersed in an aqueous solution.

Further aspects of the invention including the electrode useful in an electrochemical cell can include one or more of the following embodiments:

In an embodiment, the binder is soluble in an aqueous solution.

In another embodiment, the binder is partially soluble in an aqueous solution.

In yet another embodiment, the electrode further includes a lithium.

In an embodiment, the electrochemically active material includes a graphite.

In another embodiment, the electrochemically active material is in an amount having a range of 70-90 wt. % of the electrode.

In yet another embodiment, the electrode further includes an electrically conductive current collector which is in electrical communication with the electrically conductive material.

In an embodiment, the electrode further includes a second binder which is soluble in an aqueous solution.

In another embodiment, the solid ionically conductive polymer electrolyte is in an amount having a range of 52-15 wt. % of the electrode.

In yet another embodiment, the solid ionically conductive polymer electrolyte has an ionic conductivity of at least 1×10⁻⁴ S/cm.

In an embodiment, the solid ionically conductive polymer electrolyte has a crystallinity of at least 30%.

In another embodiment, the solid ionically conductive polymer electrolyte has a cathodic transference number greater than 0.4 and less than 1.0.

In yet another embodiment, the solid ionically conductive polymer electrolyte is in a glassy state.

In an embodiment, the electrochemically active material, the electrically conductive material, the solid ionically conductive polymer electrolyte and the binder include a plurality of dispersed, intermixed particulates.

In yet another embodiment, the electrode further includes an electrically conductive current collector; and the electrode is adhered to the electrically conductive current collector.

In an alternative embodiment, the electrochemically active material, the electrically conductive material, the solid ionically conductive polymer electrolyte and the binder include a plurality of dispersed, intermixed particulates forming a mixture; and the mixture is adhered to the electrically conductive current collector by an aqueous slurry.

In another aspect, the invention features a method of making a battery structure. The method includes the steps of selecting an electrically conductive current collector and an electrode; wherein the electrode comprises an electrochemically active material, an electrically conductive material, a solid ionically conductive polymer electrolyte, and a binder; mixing the electrochemically active material, the electrically conductive material, the solid ionically conductive polymer electrolyte, and the binder in an aqueous solution to create a slurry; positioning the slurry adjacent the electrically conductive current collector; and drying the slurry; wherein the electrode adheres to the electrically conductive current collector.

These and other aspects, features, advantages, and objects will be further understood and appreciated by those skilled in the art by reference to the following specification including Attachments A, B and C, claims and appended drawings.

### BRIEF DESCRIPTION OF THE SEVERAL VIEWS OF THE DRAWINGS

In the drawings:

FIG. 1 is a schematic of an electrochemical cell according to an exemplary embodiment of the invention;

FIG. 2 is a discharge curve for the electrochemical cell described in Example 1;

FIG. 3 is a plot of a cycle test for the electrochemical cell described in Example 1 during Lithium intercalation and deintercalation;

FIG. 4 is a discharge curve for the comparative electrochemical cell described in Example 2; and

FIG. 5 is a plot of a cycle test for the electrochemical cell described in Example 2.

### DETAILED DESCRIPTION OF THE INVENTION

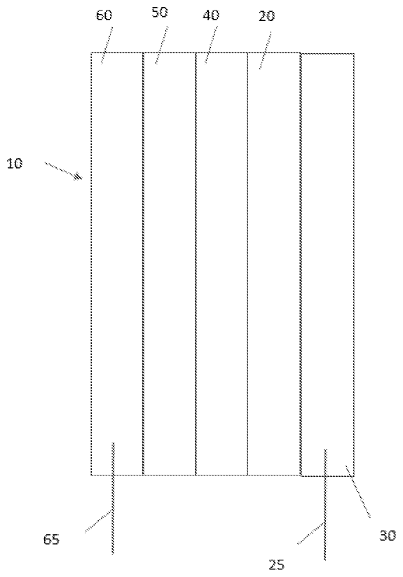

Referring to FIG. 1, an electrochemical cell 10 is shown in representative cross-section. The electrochemical cell has a first electrode 20 attached to a first electrically conductive current collector 30. The electrochemical cell also includes a second electrode 50 which is similarly attached to a second electrically conductive current collector 60. An electrolyte layer 40 is interposed between the first and second electrodes. The electrolyte layer 40 acts as a dielectric separator and enables ionic conduction between the electrodes. Each of the current collectors 30 and 60 includes a respective tab 25 and 65 extending from each respective current collector 30 and 60 so that at least a portion of the tab can extend from the cell enclosure (not shown). Each tab 25 and 65 thus can act as an electrical lead, either positive and negative for the cell.

Additional information on the design of electrochemical cells and their associated electrodes is included in the following examples and description and in PCT Application US2016/035628, which is incorporated herein by reference in its entirety except for any definitions, subject matter disclaimers or disavowals, and except to the extent that the incorporated material is inconsistent with the express disclosure herein, in which case the language in this disclosure controls. A copy of PCT Application US2016/035628 is also included as Attachment C in the present specification.

The first 20 and second electrodes 50 each contain an electrochemically active material that forms an electrochemical couple which produces electrons when the cell in under load. Although the construction of an electrochemical cell and its electrodes can vary depending on the electrochemical couple, in an aspect, the invention features an electrode having a basic or typically design known to those of ordinary skill in the art. In addition to the electrochemically active material, the electrode components typically include an electrolyte, an electrically conductive material and a binder. Liquid electrolytes or non-solid electrolytes such as, for a non-limiting example, gels, or electrolytes having a non-solid state are typically used in the prior art as the ionically conductive media in electrochemical cells. In an aspect, the invention features an electrochemical cell which includes a solid, ionically conductive, polymer electrolyte. The solid ionically conductive polymer electrolyte can function as an analyte and as a catholyte.

In one non-limiting exemplary embodiment the solid, ionically conductive polymer electrolyte can include a plurality of particulates. These particulates can be arranged in an array having a shape of a film, such as, for a non-limiting example, a planar film. The solid ionically conductive polymer electrolyte can be interposed between the electrodes to enable ionic conductivity between the electrodes while also providing the dielectric barrier necessary for the electrochemical cell. The particulates of the solid ionically conductive polymer electrolyte can be dispersed throughout the electrode whether the particulates function as an analyte and/or as a catholyte. The particulates can be interspersed with and encapsulate the particles of the electrochemically active material, the binder, and the electrically conductive material. The electrolyte includes at least one salt for the required ionic conductivity for the cell. The salt contains at least an anion and a cation. In one non-limiting exemplary embodiment, the invention features a lithium battery, wherein the diffusivity and ionic conductivity of the cation is preferably greater than that of the anion.

The present invention includes a lithium metal battery enabled to operate efficiently at a high voltage by a solid ionically conductive polymer material.

The following explanations of terms are provided to better detail the descriptions of aspects, embodiments and objects of the invention. Unless explained or defined otherwise, all technical and scientific terms used herein have the same meaning as commonly understood to one of ordinary skill in the art to which this disclosure belongs. In order to facilitate review of the various aspects and/or embodiments of the disclosure, the following explanations of specific terms are provided:

The term “depolarizer(s)” refers to a synonym for an electrochemically active substance(s), i.e., a substance(s) which changes its oxidation state or partakes in a formation or breaking of chemical bonds, in a charge-transfer step of an electrochemical reaction and an electrochemically active material. When an electrode has more than one of the electroactive substances, they can be referred to as co-depolarizers.

The term “thermoplastic(s)” refers to a characteristic of a plastic material or polymer, wherein the plastic material or polymer becomes reversibly pliable or moldable above a specific temperature, the specific temperature being typically around or at the melting temperature of the plastic material or polymer, and wherein the plastic material or polymer reversibly solidifies upon cooling below the melting temperature.

The terms “solid electrolyte(s)” and/or “solid phase electrolytes” refer to solvent free polymers and/or ceramic compounds including crystalline, semi-crystalline and/or amorphous compounds and/or compounds in a glassy state. For purposes of this application including its claims, the terms “solid electrolyte(s)” and/or “solid phase electrolyte(s)” do not refer to or include gelled or wet polymer(s), solvent(s) and/or other material(s) which depend upon a liquid, liquid phase, and/or liquid phase material for ionic conductivity.

The terms “solid(s)” and/or “solid phase(s) and/or solid phase material and/or material is a solid phase” can be used interchangeably and refer to the ability to maintain indefinitely a particular shape, wherein the “solid” is distinguishable and different from a liquid or a liquid phase or a liquid phase material or a material in a liquid phase. The atomic structure of the “solid(s)” can be crystalline or amorphous. The “solid(s)” can be mixed with or include components in composite structures. For purposes of this application including its claims, a “solid” ionically conductive or conducting material enables ionic conductivity through the “solid” material and not through any solvent, gel, liquid, liquid phase or liquid phase material, unless it is otherwise described.

The term “polymer(s)” refers to an organic compound which includes carbon-based macromolecules. Each macromolecule can have one or more types of repeating units, also known as monomers and/or monomer residues, as understood by those persons of ordinary skill in the art. A “polymer(s)” is characterized as lightweight, ductile, usually or typically electrically non-conductive, and melts at a relatively low temperature. A polymer(s) can be made into products by injection, blowing and other molding processes, extrusion, pressing, stamping, three-dimensional printing, machining and other plastic or polymer forming processes known to those of ordinary skill in the art. A polymer(s) typically has a glassy state at a temperature below the glass transition temperature or Tg of the polymer(s). The glass transition temperature is a function of polymer chain flexibility. At temperatures above the glass transition temperature, there is enough vibrational and/or thermal energy in the system of the polymer(s) to create sufficient free-volume to permit sequences of segments of the polymer macromolecule to move together as a unit. However, when in the glassy state, a polymer has no segmental motion of the polymer.

The term “ceramic(s)”, which is distinguishable from the term “polymer(s)”, refers to an inorganic, non-metallic material; ceramics typically include compounds which consist of metals covalently bonded to oxygen, nitrogen or carbon. A “ceramic(s)” is characterized as brittle, strong and non-conducting.

The term “glass transition temperature”, which is observed, determined or estimated in some but not all polymers, is a temperature or temperature range which falls between the temperature of a supercooled liquid state and the temperature of a glassy state as a polymer material is cooled. The thermodynamic measurements of the glass transition are done by measuring a physical property of the polymer, e.g. volume, enthalpy or entropy and other derivative properties as a function of temperature. The glass transition temperature is observed on such a plot as a break in the selected property (volume of enthalpy) or from a change in slope (heat capacity or thermal expansion coefficient) at the transition temperature. Upon cooling a polymer from above the Tg to below the Tg, the polymer molecular mobility slows down until the polymer reaches its glassy state.

A polymer(s) can include a crystalline, a semi-crystalline and/or an amorphous phase. The term “percentage crystallinity” of a polymer(s) refers to the percentage or amount of the crystalline phase of the polymer relative the total amount of the polymer including both the amorphous and crystalline phases of the polymer. Crystallinity percentage can be calculated via x-ray diffraction of the polymer and analysis of the relative areas of the amorphous and crystalline phases of the polymer.

The term “polymer film” generally refers to a thin portion of polymer. For the purposes of the present application, the term “polymer film” should be understood to equal a portion of polymer which is equal to or less than 300 micrometers in thickness. Ionic conductivity differs from electrical conductivity. Ionic conductivity depends on ionic diffusivity, and the properties of ionic conductivity are related by the Nernst-Einstein equation. Ionic conductivity and ionic diffusivity are both measures of ionic mobility. An ion is considered mobile in a material if the diffusivity of the ion in the material is positive, that is, greater than zero, and/or the movement of the ion contributes to a positive ionic conductivity. Ionic mobility measurements are generally taken at room temperature, that is, around 21° C., unless otherwise stated. Ionic mobility is affected by temperature. Thus, it can be difficult to detect ionic mobility at low temperatures. Equipment detection limits can be a factor in determining relatively low ionic mobility. An ion can be considered mobile in a material when a measurement of the diffusivity of the ion is at least 1×10⁻¹⁴ m²/s and preferably is at least 1×10⁻¹³ m²/s.

The term “solid polymer ionically conductive and/or conducting material(s)” refers to a solid material that includes a polymer and conducts ions as will be further described.

An aspect of the invention includes a method of synthesizing a solid ionically conductive polymer material from at least three distinct components: a base polymer, a dopant and an ionic compound. The components and method of synthesis are chosen or selected for the particular application of the material. The selection of the base polymer, dopant and ionic compound may also vary based on the desired performance of the material. For example, the desired components and method of synthesis may be determined by optimization of a desired physical characteristic (e.g. ionic conductivity).

The method of synthesis can also vary depending on the particular components and the desired form of the end material (e.g. film, particulate, etc.). However, the method includes the basic steps of mixing at least two of the components initially, adding the third component in an optional second mixing step, and heating the components/reactants to synthesis the solid ionically conductive polymer material in a heating step. In one aspect of the invention, the resulting mixture can be optionally formed into a film of desired size. If the dopant was not present in the mixture produced in the first step, then it can be subsequently added to the mixture while heat and optionally pressure (positive pressure or vacuum) are applied. All three components can be present and mixed and heated to complete the synthesis of the solid ionically conductive polymer material in a single step. However, this heating step can be done when in a separate step from any mixing or can completed while mixing is being done. The heating step can be performed regardless of the form of the mixture (e.g. film, particulate, etc.) In an aspect of the synthesis method, all three components are mixed and then extruded into a film. The film is heated to complete the synthesis.

When the solid ionically conductive polymer material is synthesized, a color change occurs which can be visually observed as the reactants color is a relatively light color, and the solid ionically conductive polymer material is a relatively dark or black color. It is believed that this color change occurs as charge transfer complexes are formed and can occur gradually or quickly depending on the synthesis method.

An aspect of the method of synthesis includes a step of mixing the base polymer, ionic compound and dopant together followed by a step of heating the mixture. The heating step can be performed in the presence of the dopant where the dopant can be in the gas phase. The mixing step can be performed in an extruder, blender, mill or other equipment typical of plastic processing. The heating step can last several hours (e.g. twenty-four (24) hours) and the color change is a reliable indication that synthesis is complete or partially complete. Additional heating past synthesis (color change) does not appear to negatively affect the material.

In an aspect of the synthesis method, the base polymer and ionic compound can be first mixed. The dopant is then mixed with the polymer-ionic compound mixture and heated. The heating can be applied to the mixture during the mixture step or the heating can be applied to the mixture subsequent to the mixing step.

In another aspect of the synthesis method, the base polymer and the dopant are first mixed, and then heated. This heating step can be applied after the mixing or during the mixing. The heating step produces a color change indicating the formation of charge transfer complexes and reaction between the dopant and the base polymer. The ionic compound is then mixed with the reacted polymer dopant material to complete the formation of the solid ionically conductive polymer material.

Typical methods of adding the dopant are known to those skilled in the art and can include vapor doping of film containing the base polymer and ionic compound and other doping methods known to those skilled in the art. Upon doping the solid polymer material becomes ionically conductive. It is believed that the doping acts to activate the ionic components of the solid polymer material, so they are diffusing ions.

Other non-reactive components can be added to the above described mixtures during the initial mixing steps, secondary mixing steps or mixing steps subsequent to heating. Such other components include but are not limited to depolarizers or electrochemically active materials such as anode or cathode active materials, electrically conductive materials such as carbons, rheological agents such as binders or extrusion aids (e.g. ethylene propylene diene monomer “EPDM”), catalysts and other components useful to achieve the desired physical properties of the mixture.

Polymers that are useful as reactants in the synthesis of the solid ionically conductive polymer material are electron donors or polymers which can be oxidized by electron acceptors. Semi-crystalline polymers with a crystallinity index greater than 30%, and greater than 50% are suitable reactant polymers. Totally crystalline polymer materials such as liquid crystal polymers (“LCPs”) are also useful as reactant polymers. LCPs are totally crystalline and therefore their crystallinity index is hereby defined as 100%. Undoped conjugated polymers and polymers such as polyphenylene sulfide (“PPS”) are also suitable polymer reactants.

Polymers are typically not electrically conductive. For example, virgin PPS has an electrical conductivity of 10⁻²⁰ S/cm. Non-electrically conductive polymers are suitable reactant polymers.

In an aspect, polymers useful as reactants can possess an aromatic or heterocyclic component in the backbone of each repeating monomer group, otherwise known as a monomer residue, and a heteroatom either incorporated in the heterocyclic ring or positioned along the backbone in a position adjacent the aromatic ring. The heteroatom can be located directly on the backbone or bonded to a carbon atom which is positioned directly on the backbone. In both cases where the heteroatom is located on the backbone or bonded to a carbon atom positioned on the backbone, the backbone atom is positioned on the backbone adjacent to an aromatic ring. Non-limiting examples of the polymers used in this aspect of the invention can be selected from the group including PPS, Poly (p-phenylene oxide) (“PPO”), LCPs, Polyether ether ketone (“PEEK”), Polyphthalamide (“PPA”), Polypyrrole, Polyaniline, and Polysulfone. Co-polymers including monomers or monomer residues of the listed polymers and mixtures of these polymers may also be used. For example, copolymers of p-hydroxybenzoic acid can be appropriate liquid crystal polymer base polymers.

TABLE 1 details non-limiting examples of reactant polymers useful in the synthesis of the solid ionically conductive polymer material along with monomer or monomer residue structures and some physical property information. TABLE 1 includes non-limiting examples where polymers can take multiple forms which can affect their physical properties.

TABLE 1

| | | Melt- | |
|---|---|---|---|
| | | ing | |
| | | Pt. | |
| Polymer | Monomer Structure | (C.) | MW |
| PPS polyphenylene sulfide | 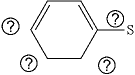 | 285 | 109 |
| PPO Poly(p- phenylene oxide) | 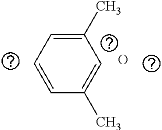 | 262 | 92 |
| PEEK Polyether ether ketone | 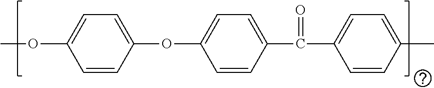 | 335 | 288 |
| PPA Polyphthalamide | 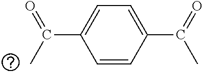 | 312 | |
| Polypyrrole | 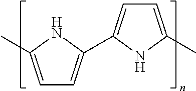 | | |
| Polyaniline Poly- Phenylamine [C₆H₄NH]ₙ | 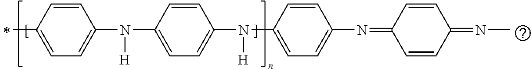 | 385 | 442 |
| Polysulfone | 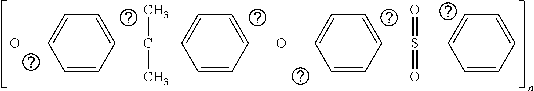 | | 240 |
| Xydar (LCP) | 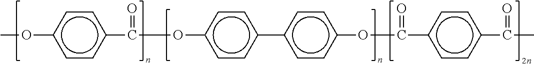 | | |
| Vcctran Poly- paraphenylene terephthalamide [—CO—C₆H₄—CO—NH—C₆H₄—NH—]ₙ | 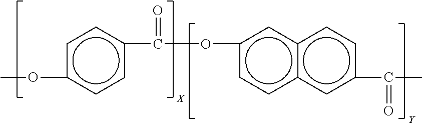 | | |
| Polyvinylidene fluoride (PVDF) | 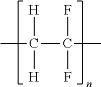 | 177° C. | |
| Polyacrylonitrile (PAN) | 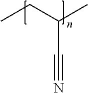 | 300° C. | |
| Polytetrafluoro- ethylene (PTFE) | 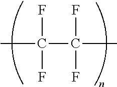 | 327 | |
| Polyethylene (PE) | 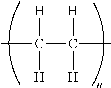 | 115- 135 | |

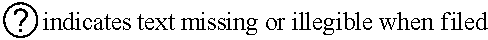

Dopants that are useful as reactants in the synthesis of the solid ionically conductive polymer material are electron acceptors or oxidants. It is believed that the dopant(s) release ions for ionic transport and mobility. It is believed that the dopant release of ions creates site(s) analogous to charge transfer complex(es) or site(s) within the polymer which allow or permit ionic conductivity.

Non-limiting examples of dopants which can be used in the present invention include quinones such as: 2,3-dicyano-5,6-dichlorodicyanoquinone (C₈C₁₂N₂O₂) also known as “DDQ”, and tetrachloro-1,4-benzoquinone (C₆C₁₄O₂), also known as chloranil, tetracyanoethylene (C₆N₄) also known as TCNE, sulfur tri oxide (“SO₃”), ozone (tri oxygen or O₃), oxygen (O₂, including air), transition metal oxides including manganese dioxide (“MnO₂”), or any suitable electron acceptor, etc. and combinations thereof. Dopants that are temperature stable at the temperatures of the synthesis heating step are useful or preferred, and quinones and other dopants which are both temperature stable and strong oxidizers quinones are very useful and even more preferred. TABLE 2 provides a non-limiting listing of dopants, along with their chemical formulas and structures.

TABLE 2

| Dopant | Formula | Structure |
|---|---|---|
| 2,3-Dichloro-5,6-dicyano- 1,4-benzoquinone (DDQ) | C₆Cl₂(CN)₂O₂ | 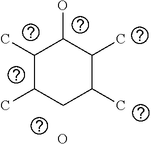 |
| tetrachloro-1,4-benzoquinone (chloranil) | C₆Cl₄O₂ | 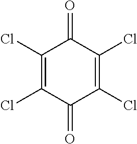 [SMILES: O=C1C(Cl)=C(Cl)C(=O)C(Cl)=C1Cl] |
| Tetracyanoethylene (TCNF) | C₆N₄ | 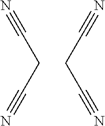 |
| Sulfur Trioxide | SO₃ | |
| Ozone | O₃ | |
| Oxygen | O₂ | |
| Transition Metal Oxides | MxO_{y} (M Transition Metal, | |
| | x and y are equal to or | |
| | greater than 1) | |

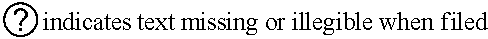

Ionic compounds that are useful as reactants in the synthesis of the solid ionically conductive polymer material are compounds that release desired lithium ions during the synthesis of the solid ionically conductive polymer material. The ionic compound is distinct from the dopant in that both an ionic compound and a dopant are required. Non-limiting examples include Li₂O, LiOH, LiNO₃, LiTFSI (LiC₂F₆NO₄S₂ or lithium bis-trifluoromethanesulfonimide), LiFSI (F₂LiNO₄S₂ or Lithium bis(fluorosulfonyl)imide), LiBOB (Lithium bis(oxalato)borate or C₄BLiO₈), lithium triflate (LiCF₃O₃S or lithium trifluoromethane sulfonate), LiPF₆ (lithium hexafluorophosphate), LiBF₄ (lithium tetrafluoroborate), LiAsF₆ (lithium hexafluoroarsenate) and other lithium salts and combinations thereof. Hydrated forms (e.g. monohydride) of these compounds can be used to simplify handling of the compounds. Inorganic oxides, chlorides and hydroxide are suitable ionic compounds in that they dissociate during synthesis to create at least one anionic and/or cationic diffusing ion. Any such ionic compound that dissociates to create at least one anionic and/or cationic diffusing ion would similarly be suitable. Multiple ionic compounds can also be useful that result in multiple anionic and/or cationic diffusing ions can be preferred. The particular ionic compound included in the synthesis depends on the utility desired for the material. For example, in an aspect where it can be desired to have a lithium cation, a lithium hydroxide or a lithium oxide convertible to a lithium and hydroxide ion can be appropriate. A lithium containing compound that releases both a lithium cathode and a diffusing anion can be used in the the synthesis method. A non-limiting group of such lithium ionic compounds includes those used as lithium salts in organic solvents.

The purity of the materials can be relevant for the prevention of unintended side reactions and for the maximization of the effectiveness of the synthesis reaction to produce a highly conductive material. Substantially pure reactants with generally high purities of the dopant, the base polymer and the ionic compound are useful, and purities greater than 98% are more useful with even higher purities, e.g. LiOH: 99.6%, DDQ: >98%, and Chloranil: >99% also useful.

In the aspect of the invention when an anode intercalation material is used as the anode electrochemically active material, useful anode materials include typical anode intercalation materials comprising: lithium titanium oxide (LTO), Silicon (Si), germanium (Ge), and tin (Sn) anodes doped and undoped; and other elements, such as antimony (Sb), lead (Pb), Cobalt (Co), Iron (Fe), Titanium (Ti), Nickel (Ni), magnesium (Mg), aluminum (Al), gallium (Ga), Germanium (Ge), phosphorus (P), arsenic (As), bismuth (Bi), and zinc (Zn) doped and undoped; oxides, nitrides, phosphides, and hydrides of the foregoing; and carbons (C) including nanostructured carbon, graphite, graphene and other materials including carbon, and mixtures thereof. In this aspect the anode intercalation material can be mixed with and dispersed within the solid ionically conductive polymer material such that the solid ionically conductive polymer material can act to ionically conduct the lithium ions to and from the intercalation material during both intercalation and deintercalation (or lithiation/de-lithiation).

Referring again to FIG. 1, the cathode current collector 60 and/or the anode current collector 30 can include aluminum, copper, or other electrically conducting film onto which the corresponding cathode 50 or anode 20 can be located or positioned. In alternative embodiments, either the cathode current collector 60 and/or the anode current collector 30 can have a planar form.

Typical electrochemically active cathode compounds which can be used in the present invention include but are not limited to: NCA—Lithium Nickel Cobalt Aluminum Oxide (LiNiCoAlO₂); NCM (NMC)—Lithium Nickel Cobalt Manganese Oxide (LiNiCoMnO₂); LFP—Lithium Iron Phosphate (LiFePO₄); LMO—Lithium Manganese Oxide (LiMn₂O₄); LCo—Lithium Cobalt Oxide (LiCoO₂); lithium oxides or phosphates that contain nickel, cobalt or manganese, and LiTiS₂, LiNiO₂, and other layered materials, other spinels, other olivines and tavorites, and combinations thereof.

In an aspect of the invention, the electrochemically active cathode compounds can be an intercalation material or a cathode material that reacts with the lithium in a solid state redox reaction. Such conversion cathode materials can include: metal halides including but not limited to metal fluorides such as FeF2, BiF3, CuF2, and NiF2, and metal chlorides including but not limited to FeCl₃, FeCl₂, CoCl₂, NiCl₂, CuCl₂, and AgCl; Sulfur (S); Selenium (Se); Tellerium (Te); Iodine (I); Oxygen (O); and related materials such as but not limited to pyrite (FeS₂) and Li₂S. The solid polymer electrolyte is stable at high voltages (exceeding 5.0V relative to the anode electrochemically active material). Thus, an aspect of the invention involves the increase of the energy density by enabling as high a voltage battery as possible. High voltage cathode compounds are preferred in this aspect. Certain NCM or NMC material can provide such high voltages with high concentrations of the nickel atom. In an aspect, NCMs that have an atomic percentage of nickel which is greater than that of cobalt or manganese, such as NCM523, NCM712, NCM721, NCM811, NCM532, NCM622 and NCM523, and other variations are useful to provide a higher voltage relative the anode electrochemically active material.

An electrically conductive material is necessary to establish electrical communication between electrochemically active particles and with the associated current collector for the support of electrical conduction within and to and from the electrode. Such electrically conductive material typically contains particulate carbon and various graphites and carbons which are useful for this purpose such as. carbon black, a natural graphite, a synthetic graphite, a graphene, other electrically conductive materials comprising carbon, a conductive polymer, a metal particle, and a combination of at least two of the preceding components.

Binders act to maintain electrode integrity and adhesion to the current collector. Like the electrically conductive material and the electrolyte, the binders are not electrochemically active. Thus, the less binder added, the more electrochemically active material can be added—thus increasing the energy density and cell capacity. Binders which are soluble in aqueous solution are substantially soluble in water-based solvents, and can include Carboxymethyl cellulose or “CMC”, and styrene-butadiene rubber or “SBR”, similar aqueous soluble binders and mixtures thereof.

In addition to SBR and CMC, other binders which can be dispersed or are soluble in an aqueous solution include: Polytetrafluoroethylene (PTFE), Ethylene propylene diene monomer (EPDM) rubber and other rubbers, poly-polystyrene sulfonate (PEDOT-PSS), Polyacrylic acid (PAA), Poly(methyl acrylate) (PMA), Poly(vinyl alcohol) (PVA), Poly(vinyl acetate) (PVAc), Polyacrylonitrile (PAN), Polyisoprene (Plpr), Polyaniline (PANi), Polyethylene (PE), Polyimide (PI), Polystyrene (PS), Polyurethane, Polyvinyl butyral (PVB), Polyvinyl pyrrolidone (PVP) and modifications and combinations thereof. Additional natural binders which can be dispersed or are soluble in an aqueous solution include: Amylose, Caseine, Cyclodextrines (carbonyl-beta), Cellulose (natural), Starches, alginate, chitosan, gums (e.g., gellan, guar, xanthan, karaya, tara, tragacanth, and arabic), agar-agar, pectin, and carrageenan.

In an aspect of the invention, chemical and/or physical modifications to these natural binders can be made. Combinations of one or more of the natural and/or modified binders can be used. The binders can be dispersed in an aqueous solution such that the binder particulates are distributed for coherence of the electrode and/or for maintenance of electrical conductivity between the electrode and a respective electrode lead. Further, binders which are soluble in an aqueous solution can be used in the present invention. In an aspect, the invention features binders which can be crosslinked if desired, e.g. PAA with CMC, and the crosslinked binder mixture can include tertiary and other additional binders to provide desired mechanical benefits. In other aspects, the invention features binders which are soluble and are well dispersed in the water-based solvent, and/or binders which are partially soluble or otherwise dispersed.

Processes for manufacturing electrochemical cells also vary depending upon the construction of the cell, the electrochemical couple, the other components or ingredients of the cell, and the cell size. The electrochemically active material needs to be in ionic communication with the solid polymer electrolyte, and in electrical communication with the electrically conductive material.

In an aspect, the invention features a plurality of particles of each electrode component intermixed and dispersed such that the particles are intimately mixed. The binder must be added to the mixture. Typically, a non-aqueous soluble binder such as PVDF can be added in solution in a mixing step.

Non-aqueous binders may not be compatible with certain electrode ingredients or components, as further discussed below, however. Such non-aqueous binders can result in poor electrical communication between an electrode and a current collector. If an aqueous binder is substituted for the non-aqueous binder in such applications, the aqueous solution can degrade the electrolyte. Therefore, in such applications, the electrolyte is added after the aqueous solution is driven off in a drying or heating step. Prior art solid electrolytes can be incompatible with aqueous binders, however. Prior art solid electrolytes cannot be added after a drying step, as the electrode is cast and additional mixing would render an incoherent electrode. Inclusion of prior art solid electrolytes such as PEO-salt complexes in the electrode mixture prior to drying can result in electrolyte degradation during exposure to the aqueous solution. Specifically, the salt contained within the electrolyte can react with water resulting in unreactive or lower performing reactants.

In an aspect, it has been surprisingly found that the solid polymer electrolyte of the present invention can be used with an aqueous soluble binder without experiencing any performance degradation, while producing a coherent electrode with excellent electrical communication with the associated current collection. Additional details will be described in the following Examples.

### Example 1 (Comparative Electrochemical Cell Example)

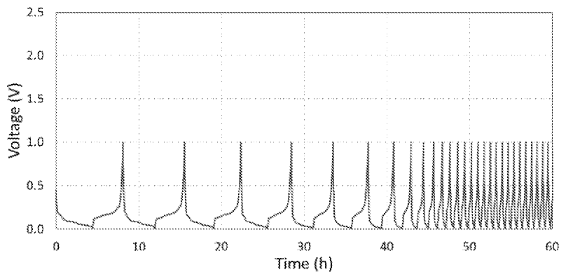

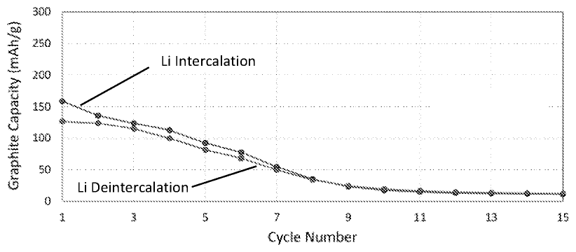

An electrochemical cell with a lithium ion graphite intercalation active material was constructed generally according to the electrochemical cell description provided above in association with FIG. 1. Details of the components and their weight percentages is provided in TABLE 3. Carbon black included LiTX50 from Cabot. Natural Graphite intercalation material included SPGPT803 from Targray. The binder consisted of Polyvinylidene fluoride or PVDF along with a non-aqueous slurry of N-Methyl-2-pyrrolidone or “NMP” solvent. The resulting slurry was adhered to a copper foil current collector and a coin cell was constructed. The cell was cycled and voltage over time was graphed. FIG. 2 shows the resulting discharge curve over many cycles. Graphite capacity per cycle was calculated during Lithium intercalation and deintercalation, as shown in FIG. 3. FIGS. 2 and 3 demonstrate a significant capacity fade resulting in poor performance after approximately ten cycles.

### Example 2

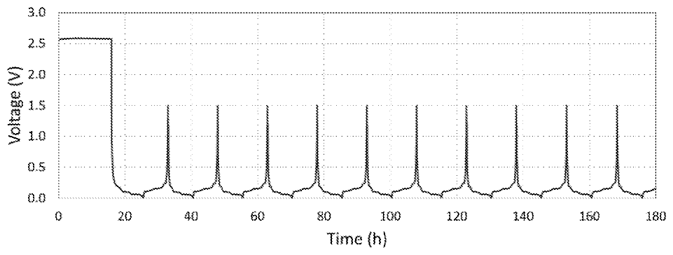

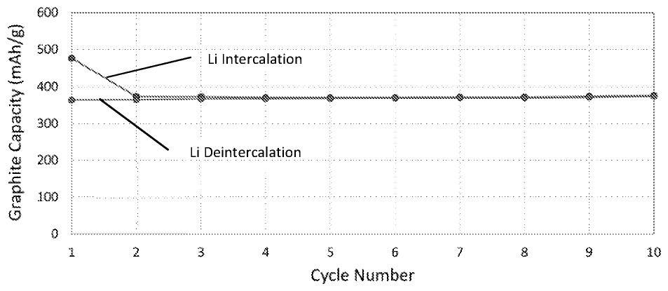

An electrochemical cell with a lithium ion graphite intercalation active material was constructed generally according to the electrochemical cell description provided above in association with FIG. 1. Details of the components and their weight percentages is provided in TABLE 3. Carbon black included LiTX50 from Cabot. Natural Graphite intercalation material included SPGPT803 from Targray. The binder consisted of a mixture of Carboxymethyl cellulose or CMC and styrene-butadiene rubber or SBR in a ratio of 60/40 wt. %, along with an aqueous slurry. Apart from the binder and associated solution, the electrochemical cell was constructed following the same procedure as in Comparative Example 1. The resulting slurry was adhered to a copper foil current collector and a coin cell was constructed. FIG. 4 shows the resulting discharge curve over many cycles. Graphite capacity per cycle was calculated during Lithium intercalation and deintercalation, as shown in FIG. 5. FIGS. 4 and 5 demonstrate repeatable cycling with little to no capacity loss over numerous cycles.

TABLE 3

| | Example 1 | Example 2 |
|---|---|---|
| | (wt. %) | (wt. %) |
| Active Material: Natural Graphite | 83% | 83% |
| Electrically Conductive Material | 2% Carbon | 2% Carbon |
| | Black | Black |
| Electrolyte: solid polymer | 11% | 11% |
| electrolyte | | |
| Binder | 4% PVDF | 4% CMC:SBR |
| | in NMP | (60:40) in water |

FIG. 2, and FIG. 3 show graphical representation data from cycling of the cells described in Example 1. In FIG. 2, the voltage per time is depicted with the voltage peaks of each cycle taking place with decreasing frequency after about the first four cycles. The decreasing area under each cycle also indicates decreasing capacity which is confirmed in FIG. 3, and which depicts the capacity of the cell during charge (intercalation), and discharge (deintercalation). Specifically, the capacity measured in mAh/g of active anode material is graphically depicted per cycle. Again, the anode loses significant capacity in every cycle.

It is believed that the anodes are losing adhesion with the anode current collector, which increases resistance. This resistance lowers the voltage and the associated capacity. The adhesion loss is analogous to a hose being gradually clamped closed every cycle, with less and less fluid being able to flow because of the reduced flow area. The anode electrode made with the non-aqueous slurry and non-aqueous soluble binder does not provide adequate adhesion.

In Example 2, the goal was to improve the current collector adhesion, and thus prevent the current restriction that occurred with the Example 1 (Comparative) cells. The cells from Example 2 were initially kept for 16 hours and the OCV was very stable over this time. The cells were then cycled at a C/7 charge-discharge. Referring to FIG. 4, the Example 2 cell first cycle efficiency was 76.2%, and the intercalation (graphite) averaged about 364-374 mAh/g. FIG. 5 shows the capacity of the cell during charge (intercalation), and discharge (deintercalation) over the first ten cycles. No capacity fade is shown, and a 99.6% cycle efficiency is demonstrated.

It is believed that the solid ionically conductive polymer electrolyte prevents water from degrading the electrolyte. Thus, the combination of the aqueous binder and the solid ionically conductive polymer electrolyte provides superior electrode performance while enabling the elimination of a costly electrode manufacturing step.

What is claimed is:

1. An electrode useful in an electrochemical cell comprising:
an electrochemically active material;
an electrically conductive material;
a solid ionically conductive polymer electrolyte; and
a binder;
wherein the binder is dispersed in an aqueous solution.

2. The electrode of claim 1, wherein the binder is soluble in an aqueous solution.

3. The electrode of claim 1, wherein the binder is partially soluble in an aqueous solution.

4. The electrode of claim 1 further comprising a lithium.

5. The electrode of claim 1, wherein the electrochemically active material comprises a graphite.

6. The electrode of claim 1, wherein the electrochemically active material is in an amount having a range of 70-90 wt. % of the electrode.

7. The electrode of claim 1 further comprising an electrically conductive current collector which is in electrical communication with the electrically conductive material.

8. The electrode of claim 1 further comprising a second binder which is soluble in an aqueous solution.

9. The electrode of claim 1, wherein the solid ionically conductive polymer electrolyte is in an amount having a range of 52-15 wt. % of the electrode.

10. The electrode of claim 1, wherein the solid ionically conductive polymer electrolyte has an ionic conductivity of at least 1×10⁻⁴ S/cm.

11. The electrode of claim 1, wherein the solid ionically conductive polymer electrolyte has a crystallinity of at least 30%.

12. The electrode of claim 1, wherein the solid ionically conductive polymer electrolyte has a cathodic transference number greater than 0.4 and less than 1.0.

13. The electrode of claim 1, wherein the solid ionically conductive polymer electrolyte is in a glassy state.

14. The electrode of claim 1, wherein the electrochemically active material, the electrically conductive material, the solid ionically conductive polymer electrolyte and the binder comprise a plurality of dispersed, intermixed particulates.

15. The electrode of claim 1,
wherein the electrode further comprises an electrically conductive current collector; and
wherein the electrode is adhered to the electrically conductive current collector.

16. The electrode of claim 15,
wherein the electrochemically active material, the electrically conductive material, the solid ionically conductive polymer electrolyte and the binder comprise a plurality of dispersed, intermixed particulates forming a mixture; and
wherein the mixture is adhered to the electrically conductive current collector by an aqueous slurry.

17. A method of making a battery structure comprising the following steps:
selecting an electrically conductive current collector and an electrode;
wherein the electrode is comprised of an electrochemically active material, an electrically conductive material, a solid ionically conductive polymer electrolyte, and a binder;
mixing the electrochemically active material, the electrically conductive material, the solid ionically conductive polymer electrolyte, and the binder in an aqueous solution to create a slurry;
positioning the slurry adjacent to the electrically conductive current collector; and
drying the slurry;
wherein the electrode adheres to the electrically conductive current collector.
